(19) United States
(12) Patent Application Publication
(10) Pub. No.: US 2010/0246009 A1
(43) Pub. Date: Sep. 30, 2010

(54) Optical coating

(76) Inventors: Todd A. Polley, Suwanee, GA (US); Andrew Tye Hunt, Atlanta, GA (US); Yongdong Jiang, Norcross, GA (US); Eric Stepowany, Roswell, GA (US); Scott Flanagan, Atlanta, GA (US)

Correspondence Address: William M. Brown;nGimat Co., 5315 Peachtree Industrial Blvd., Atlanta, GA, 30341-2107, US

(21) Appl. No.: 12/438,374

(22) PCT Filed: Aug. 21, 2007
(86) PCT No.: PCT/US07/18477

§ 371 Date: Feb. 23, 2009

Related U.S. Application Data
(60) Provisional application No. 60/839,807, filed on Aug. 24, 2006.

(51) Int. Cl. G02B 5/28; H01B 1/00; G02B 5/00; B32B 5/16; G02B 1/10

(52) U.S. Cl. 359/578; 252/501.1; 252/582; 428/336; 428/323; 977/773

(57) ABSTRACT

Optical coating materials comprise a transparent matrix material having dispersed nanoparticles comprising between 1 and 20 volume percent of the optical coating material. The coating materials are used to form optical coatings on substrates, such as glass/ceramic, polymer or metal, to alter the color or other optical properties. The nanoparticles are semiconductive material or elemental metals or elemental metal alloys that exhibit surface plasmon resonance.

The present invention is directed to optical materials and to optical coatings formed using such materials. Coatings in accordance with the invention are useful, for example, in eyeglasses, cameras, projectors, decorative glass, and for any transparent or translucent substrate where it is desired to limit transmission of light at select wavelengths. This may alter the color of the coated substrate or may inhibit transmission of undesirable light, such as UV light through eyeglasses or a camera lens.

### BACKGROUND OF THE INVENTION:

The color of an optical transmission filter is determined by the wavelengths of light transmitted. The transmitted wavelengths can be restricted to a desired range by either of two mechanisms: the interference of light in thin films or the absorption of light by colored substances. Interference filters are produced from one or more thin layers of dielectric materials where the color is controlled by the number of layers and by the thickness and refractive index of each layer. The disadvantages of interference filters include high angle sensitivity (the observed color changes when the filter is tilted), reduced light transmission at all wavelengths (requiring higher illumination levels), complex design (filter stacks typically must be designed using a computer model), and sensitivity to layer thickness variations and sensitivity to scratches (the interfering films are usually applied to the surface of optics). Alternatively, absorptive filters are constructed using a colored substance applied to or dispersed in a dielectric medium. The colored substance is typically an inorganic compound or an organic dye. Organic dyes are widely used due to their ease of processing, compatibility with polymers, and wide range of available wavelengths. However, organic dyes are subject to fading when used with intense light sources, including sunlight. In addition, organic dyes are not stable at high temperatures (>˜300° C.) and thus cannot be dispersed in glass or used in high temperature applications. Inorganic colorants are colorfast and heat stable, but have greater limitations on the available wavelength ranges, and many of the elements once used as colorants are no longer used due to their toxicity or radioactivity. The colors of transition metals and rare earths are due to the electronic transitions of the metal ions.

As one prior art example, uranium can impart a color to glass ranging from yellow-green to orange. Uranium is generally no longer used as a colorant due to concerns over toxicity (similar to lead) and radioactivity. Antique pieces containing uranium can often be authenticated with a Geiger counter, due to the radioactivity.

Nanoparticles can also create color through absorption bands due to a bandgap mechanism (for semiconductors) or surface plasmon resonance (for metals).

Semiconductor nanoparticles, such as CdSe and ZnTe, show effects not seen in bulk materials. Whereas the behavior of the bulk materials is characterized by the energy of the valence and conduction bands, the band structure becomes discrete and the energy gap is increased in a quantum dot. This shift leads to transitions that are observable in the visible spectrum. The band gap (and hence the absorption wavelength) is highly dependent on nanoparticle size. In addition, the energy of the excited state is not dissipated via heat (no vibrational modes), but rather by fluorescence, so semiconductor quantum dots are generally highly efficient fluorophores.

A different mechanism causes the absorption of light by metal nanoparticles. The Lycurgus cup (4^{th} century AD) is a famous example of glass that derives its color from gold and silver nanoparticles, and it transmits red light while reflecting green, although the reasons behind the coloration were unknown to the ancient craftsmen who created it. Metals can create color when light interacts with conductive nanoparticles in a dielectric medium to induce local dipoles (surface plasmon resonance). Surface plasmon resonance arises from the interaction of the “electron cloud” of the conduction band electrons in a conductor with the oscillating electric field of light. The electric field component of light polarizes the free electron cloud in conductive nanoparticles. The resonance frequency is affected by particle size, shape, surface roughness, composition, and surrounding media (matrix material).

It has been previously proposed that when an electric field displaces electrons in a metal, the Coulombic force due to the atomic nuclei in the metal pulls back, resulting in a characteristic bulk plasmon oscillation frequency (ωₚ) (equation 1),

$${ω}_{p}^{2} = \frac{4 π {ne}^{2}}{{ɛ}_{0} m} \qquad ( 1 )$$

where n is the electron density,

e is the charge of an electron,

∈₀ is the permittivity of free space, and

m is the mass of an electron.

In a <10 nm nanoparticle, the oscillations are constrained by the particle boundaries, and the resonance frequency can be predicted for spherical particles using Mie theory. The color of the light absorbed by conductive particles in a dielectric medium is determined by the composition, shape and size of the nanoparticles and dielectric properties of the matrix. Surface plasmon resonance shows some dependence on particle size, but the effect is much smaller than the size dependence of the band-gap absorption observed in semiconductor nanoparticles. A strong dependence on the shape of the nanoparticles is now well established, and the effect of the aspect ratio of gold nanorods on the optical absorption spectrum has been successfully modeled. Thus, the wavelength range for this type of filter can be tuned through control of the nanoparticles and matrix properties.

Modern advances in the understanding of nanoparticles have reached the point where the factors controlling the size, and to a lesser degree, the shape of the particles are well established. Transmission of light for each color of the visible spectrum has been achieved using Ag and Au nanoparticle dispersions by varying the composition (Ag/Au ratio), particle size and shape. While much progress has been made recently in understanding the effect of nanoparticle shape, size, aspect ratio and refractive index of the medium on the surface plasmon resonance, relatively little work has been done to explore the effect of nanoparticle and matrix composition on the surface plasmon resonance derived optical properties in coatings. Nanoparticles (2-15 nm) of various alloys, including Au/Ag, Au/Pt, Pd/Pt, Cu/Pd and Cu/Pt, have been reported, but optical properties of these particles in a dielectric matrix at previously achievable loading levels are very limited or not present.

At present, only a small number of materials are known that have surface plasmon resonances in the visible spectrum: the alkali metals (group IA) and the coinage metals (group IB, Cu, Ag and Au). The alkali metals are highly reactive and less suitable for optical filter applications. Copper nanoparticles are frequently unstable to oxidation in air. Gold and silver nanoparticles have been widely studied due to a resistance to oxidation and a propensity to form nanoparticles. Little has been done with multi-element compositions (e.g., alloy nanoparticles), other than Au/Ag and Au/Cu alloys.

It is difficult to theoretically predict the effects that alloying gold or silver with other metals will have on the plasmon resonance. Equation (1) suggests that modification of the free electron density by manipulating the elemental composition would have a significant effect on the plasmon resonance frequency, with lower free electron densities leading to longer wavelength absorptions. If this were the only effect, gold and silver would be expected to yield nearly identical absorption frequencies, since their free electron densities are 5.90 and 5.86×10²⁸ e/m³, respectively. However, the surface plasmon extinction cross-section (Cₑₓₜ) for spherical particles is given by equation 2,

$${C}_{ext} = \frac{24 {π}^{2} {R}_{p}^{3} {ɛ}_{m}^{3 / 2}}{λ} \frac{{ɛ}_{p}^{″}}{{( {ɛ}_{p}^{′} + 2 {ɛ}_{m} )}^{2} + {ɛ}_{p}^{″2}} \qquad ( 2 )$$

where

Rₚ is the particle radius,

∈ₘ is the dielectric function of the surrounding matrix,

λ is the wavelength of light,

∈ₚ′ is the real part of the dielectric function of the nanoparticles, and

∈ₚ″ is the imaginary part of the dielectric function of the nanoparticles.

Thus, the dielectric function of the metal plays a role as well. This function is not easily predicted with precision for alloy particles, and there is little published data to use as a guide. Thus, there remains a need for empirical determination of the optical effects of metal alloys and of nanoparticle mixtures.

Of particular interest are nanoparticles of Groups VIII, IB and IIB of the periodic table listed in Table 1 below:

TABLE 1
Groups VIII, IB and IIB.

| VIII | | | IB | IIB |
|---|---|---|---|---|
| Iron | cobalt | nickel | copper | zinc |
| 26 | 27 | 28 | 29 | 30 |
| Fe | Co | Ni | Cu | Zn |
| ruthenium | rhodium | palladium | silver | cadmium |
| 44 | 45 | 46 | 47 | 48 |
| Ru | Rh | Pd | Ag | Cd |
| osmium | iridium | platinum | gold | mercury |
| 76 | 77 | 78 | 79 | 80 |
| Os | Ir | Pt | Au | Hg |

The selection of metals from groups VIII and IIB to alloy with silver and gold facilitates processing due to the similarity with gold and silver. As an added benefit, Ir, Pd, and Pt are oxidation-resistant. Elements from the first row are more easily oxidized, especially in high-surface area forms. Os, Cd and Hg are also oxidation-resistant, but have drawbacks relating to their safe use and disposal.

The invention is intended to include the use of single element metal nanoparticles, nanoparticles that are alloys of two or more metals, and mixtures of such nanoparticles. Because useful nanoparticles must be in metallic form, nanoparticles of metals and metal alloys that do not readily oxidize or have a stable native oxide thickness less than the radius of the particle are preferred for many applications, and, indeed, for optical materials to be applied by certain methods described herein, it is necessary that the nanoparticles contain a metallic phase. It is to be appreciated that because of their extremely small size and therefore high surface area per weight of nanoparticles, nanoparticles are particularly subject to oxidation.

Another aspect of the present invention is the inclusion of the metal nanoparticles in a dielectric medium that also serves to protect the metal from oxidation, thus enabling most any metal or alloy to be used. Different metals and different metal alloys produce different optical effects, and it is in some cases worth the effort to produce optical materials that incorporate oxidizable metal nanoparticles, provided that such nanoparticles are sufficiently protected against oxidation within the matrix of the optical materials so as not to oxidize over time. Also, the addition of some less reactive metals to more reactive metals or addition metals that form protective oxides to other metals that do not form protective oxides can yield alloys that have increased oxidation-resistance. The combination of two or more metals may yield the similar light effect of a single metal or other alloy, but may be preferred due to better metal stability.

Nor is the invention limited to the use of Group VIII, IB and IIB elements. It is known that other metals, including rare earth metals, e.g., uranium, likewise alter optical properties of a transparent matrix through surface plasmon resonance. Toxicity and/or radioactivity of various metals may counter-indicate their use for many applications, although use of such metals in particular specialized optical applications are considered to be within the scope of the present invention.

As noted above, the incorporation of metal particles in transparent material, particularly glass, dates back to antiquity. To this date, metal nanoparticles are incorporated into glass and other transparent matrices to alter the optical transmission properties of the matrices.

However, incorporation of metal nanoparticles into glass is problematic for glass producers, particularly glass manufacturers who produce glass in bulk quantities. While optically altered glass for specialized uses is described herein, it is to be appreciated that for most applications, it is desired to produce glass that is as clear and colorless as possible. Such glass may be appropriately coated later for various optical and strength effects. If glass is produced in a processing line and metal precursors and/or metal nanoparticles are incorporated into the glass batch, it is very difficult to remove all metals from the processing tank and line. Thus the production of nanoparticle-containing bulk glass fouls a glass processing line for subsequent production of clear, colorless glasses or other colored glasses.

Also, while the invention is frequently discussed herein as relating to coating glass substrates, it is to be understood that when coating of glass is discussed herein, other transparent or translucent materials can be similarly coated with optical coating materials of the present invention. Such alternative materials may be polymeric or mineral, e.g., transparent or translucent crystalline or amorphous, naturally occurring or artificially produced, inorganic material. In some such materials, it may be impossible to incorporate nanoparticles or any other optical modifying materials, thus requiring that a coating be applied to achieve the desired optical alteration. Further the substrate may not be transparent or translucent, and a color effect similar to a ceramic glaze may be provided by the materials of the present invention. If the substrate is reflective in nature the present materials optical effects can be enhanced due the light traveling in and then out of the optical material of the present invention.

It is therefore often preferred, that to impart desired optical filtering capabilities to glass or other optical substrate materials, nanoparticles be provided in an optical coating material as a film, particularly a thin film, i.e., 10 microns thick or less, preferably 1 micron thick or less. The difficulty in doing so lies in loading an optical coating material with a sufficient amount of nanoparticles such that a thin film of the optical material provides the same optical effects that a lesser concentration of nanoparticles within a thicker, e.g., bulk glass, substrate greater than 0.5 mm provides. Herein are described techniques for producing thin film optical coatings with sufficiently high loading of nanoparticles, e.g., between about 1% by volume to 20% by volume, that a desired amount of light filtering occurs from a thin film.

The nanoparticles in the optical coating material are normally contained within an optically transparent or translucent substrate. The substrate may be an inorganic glassy material, such as garnet, spinel, silica, borosilicate glass, float glass or may be crystalline, such as crystalline ceria, alumina, barium titanate, strontium titanate, barium strontium titanate, and mixtures thereof. Silicone is a desirable matrix material for certain applications, as are certain organic polymeric materials, such as polyvinyl pyrrolidone (PVP), polyethylene terephthalate (PET), polypropylene (PP), oriented polypropylene (OPP), polycarbonate, a liquid crystal polymer (LCP), and composites such as fiberglass.

### SUMMARY OF THE INVENTION

In accordance with the present invention, optical coating materials are described that contain between about 1 and about 20 volume %, preferably between about 5 and about 20 volume %, nanoparticles having particle size (diameter for spherical or maximum dimension for non-spherical) of 1-50 nanometers. The nanoparticles are formed of materials selected from semiconducting materials (e.g., III-V compounds and semiconducting oxides), metals, and mixtures thereof. Thin films of optical coating materials having thicknesses of between 10 nanometer and 10 microns, preferably between 10 nanometers and 1 micron (1000 nanometers) are an aspect of the invention. Transparent matrices for the optical coating materials include inorganic compounds, including glasses, minerals, and polymeric materials. Production of such materials and thin films of such materials on transparent or translucent optical substrates are another aspect of the invention.

### BRIEF DESCRIPTION OF THE DRAWINGS

FIG. 1 is a graph showing transmission of glass bare, and alternately coated with silica containing gold, silver and silver-gold alloy.

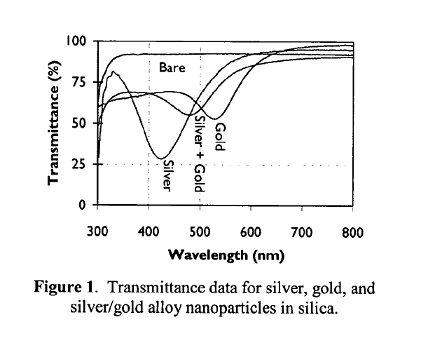

FIG. 2 is a cross-sectional view of a substrate coated with an optical coating in accordance with the invention.

FIG. 3 is a cross-sectional view of a substrate on which is formed a tunable optical coating.

### DETAILED DESCRIPTION OF CERTAIN PREFERRED EMBODIMENTS

Nanoparticles of semiconducting compounds, e.g., III-V compounds and semiconductive oxides, and metals and metal alloys are useful in the invention, although metallic nanoparticles are of most immediate interest herein. The metal or metal alloy must be capable of altering optical transmission through surface plasmon resonance. For many applications, oxidation-resistant metals, particularly gold and silver are preferred, as well as oxidation-resistant alloys of gold and silver. Gold and silver nanoparticles are known to alter optical properties, e.g., color, within the visible range. Platinum and platinum alloys are other useful materials for forming nanoparticles that exhibit surface plasmon resonance, although platinum generally has its maximum absorption peak in the UV range, a useful property for many applications. Other metals and alloys may alter optical properties at various wavelengths throughout the UV, visible and IR spectra and even more broadly throughout the electromagnetic spectra.

Typically, each metal has an absorption peak at a particular wavelength, although this is somewhat modified by the size and shape of the nanoparticle. Alloys of two metals tend to have an absorption peak between the absorption peaks of the two metals. Mixtures of nanoparticles tend to produce absorption peaks at the wavelengths of the individual metal absorption peaks with the intensity at each peak being dependent upon the fractional volume of each metal.

Metals that are subject to oxidation, particularly in nanoparticulate form, are also useful, if either alloyed with other metals so as to reduce or eliminate oxidation or encapsulated in protective material, such as silica, silicone, or polymer, before oxidation can occur. However, the absorption properties of the partially oxidized or encapsulated metal particle will likely be altered by the effective change in the dielectric properties of the matrix, which now includes the oxidized material or the encapsulating material.

Processes that form particulates and/or thin films from vapor and/or finely divided aerosols are useful methods for forming nanoparticles, nanoparticle containing optical materials, and thin film optical coatings of such materials in accordance with the present invention. One such process is combustion chemical vapor deposition (CCVD) and modifications thereof, described, for example, in U.S. Pat. Nos. 5,652,021 and 5,997,956, the teachings of each of these being incorporated herein by reference. Vapor deposition processes are useful for forming both thin films in continuous layers and as partial layers of islands that represent nucleation sites that resemble nanoparticles when incorporated inside a matrix. Alternatively nanoparticles can be attached to the surface and incorporated within the matrix, depending upon whether the vapor produced by combustion, e.g., a directed flame in which precursor material is burned, precipitates on a substrate, such as an optical substrate, or within a gas stream. CCVD precursor chemicals for depositing both metals and metal oxides are described in U.S. Pat. No. 6,208,234, the teachings of which are incorporated herein by reference. Nanoparticles can thus be formed by either depositing the nanoparticle or by forming the discrete nanophase by growth morphologies.

Using CCVD to deposit nanoparticle and matrix simultaneously from vapors, high metal nanoparticle loadings without agglomeration are possible. In the CCVD process, precursors are dissolved in a solvent, which acts as the fuel. This solution is atomized to form very small droplets by means of an atomizer, such as is described in U.S. Pat. No. 6,276,347, the teachings of which are incorporated herein by reference. The resulting mist is carried by an oxygen-containing stream to a flame. The flame provides the energy for the precursors to react and form a vapor to deposit on the substrate. Although flame temperatures are usually in excess of 800° C., the substrate may dwell in the flame only briefly, thus remaining cool (<100° C.). The temperature flexibility allows ceramic, metal, and polymer substrates to be coated without degradation.

Published international patent application WO02/02246 A1, the teachings of which are incorporated herein by reference, describes co-deposition of two or more materials, such as particulates and a matrix, by two CCVD flames, one depositing particulates and one depositing matrix. Such a technique can be used to deposit nanoparticles, e.g., gold, silver, platinum, and alloys of these metals, along with a number of transparent matrices, particularly oxides, such as silica, tin oxide, barium titanate, and barium strontium titanate.

It is desirable that the plasmon effect nanoparticles, or at least a major portion of the plasmon effect nanoparticles are isolated from each other, i.e., not touching each other. To provide an optical coating in which a major portion of the plasmon effect nanoparticles are isolated from each other, an optical coating may be formed by alternating deposition of matrix material, plasmon effect nanoparticles, and matrix material. Multiple layers of matrix material and plasmon effect nanoparticles may be deposited. At least one plasmon effect nanoparticle layer is necessary, but preferably at least three layers of plasmon effect nanoparticles are deposited, more preferably at least six layers of plasmon effect nanoparticles. The alternating matrix layers can each be of any thickness, although it is preferred to have thin layers of matrix material, provided the layers of matrix material are thick enough to provide sufficient separation of plasmon effect nanoparticles in separate plasmon effect nanoparticle layers and to adequately embed the plasmon effect nanoparticles. To this end, the matrix layers are typically between about 20 and about 1000 nanometers thick. When depositing plasmon effect nanoparticles on a matrix material layer, the plasmon effect nanoparticles should cover between about 1 to about 60% of the surface of matrix material layer on which the plasmon effect nanoparticles are deposited, preferably between about 3 to about 40%.

Deposition from atomized liquids, including solutions and suspensions of particulates, need not involve a flame. Polymers, suspensions of particulates, and fluids containing both dissolved or suspended polymers (or polymer precursors) and particulates are described in U.S. Pat. No. 6,939,576, the teachings of which are incorporated herein by reference. Such techniques can be used to deposit matrices of polymers such as silicone or PVP or silicone or PVP that contain pre-formed semiconductor or metal nanoparticles. Heat, other than flame-produced heat, may be used to vaporize water or solvent in which polymer is dissolved or suspended such that a film that is deposited is free of or substantially free (to the extent it does not functionally affect the properties of the polymer) of the fluid in which it was dissolved or suspended. If silicone is the matrix, the film that is deposited may be further cured by post-deposition heating. Post-deposition heating may be used to cure cross-linkable organic polymers as well.

Generally, it is contemplated that the optical material coatings will be directly deposited on the substrate. This would be the case, for example, with the deposition of gold or silver nanoparticles in a silica matrix. On the other hand, if the matrix is a polymer, it is conceivable that an optical material in which nanoparticles are dispersed in the matrix may be prepared in bulk and this material subsequently applied as a thin film to the optical substrate. This might be done with silicone as the matrix that contains nanoparticles. The silicone containing the matrix would need to have some fluidity; curing subsequent to application as a thin film would further cross-link and harden the thin film. The metal nanoparticles use in such polymer composites could be highly stabile in the polymer medium so that they do not bind with each other's surfaces, thus minimizing the optical effect. Or the light-interactive nanomaterial is made as a core with a shell that isolates it from other cores.

Formation of metal or metal alloy nanoparticles from metals that are easily oxidized, such as first row transition metals, requires additional localized environment control so that the oxygen partial pressure is low enough that a pure oxide does not form. Even if continuous films of these metals can be formed by control of oxygen levels, the high surface area of metal nanoparticles can result in oxidation of the nanoclusters that are produced if exposed to excessive levels of oxygen prior to passivation. Combustion processing and non-flame-produced nanoparticles of such metals may readily oxidize when exposed to air or other oxidizing agent. Another method for preventing the oxidation of reactive nanoparticles is encapsulation of the reactive nanoparticles within a polymer. A polymer, such as silicone or PVP may then be mixed with a suspension of reactive nanoparticles, the polymer dissolving in or becoming co-suspended in a suspending fluid. Or the fluid may already contain the suspended or dissolved polymer when the metal oxide particulates are added. A reducing agent could also be included to help stability of the desired phase. This material may then be applied to an optical substrate, e.g., spin or dip coating or as atomized droplets, along with thermal energy to drive off the suspending fluid, leaving the nanoparticle/polymer matrix film on the substrate. Because the nanoparticles are dispersed throughout the matrix, the nanoparticles protected from oxidation by the atmosphere or other environmental oxidizing agents. An inert atmosphere may be required in some or all of the processing steps until a securely passivated layer is obtained.

While having to make a metal of some reactive elements presents a problem, it may not be required to start with unoxidized material. CCVD or other techniques may be used to produce metal oxide particulates. These metal oxide particulates may then be suspended in a non-oxidizing fluid and exposed to a strong reducing agent, such as lithium hydride or lithium aluminum hydride to produce nanoparticles that are of elemental metal, or at least have elemental metal surfaces. It is desired that any residual compound from the reducing agent be a non-conductive component of the matrix.

The greater variety of metals and/or semiconductor nanoparticles available for incorporation into coating materials in accordance with the invention, the greater variety of optical effects that can be achieved in the optical coating materials of the invention. As noted above, if a mixture of nanoparticles is used, the optical absorption will generally be additive, i.e., the first metal peak plus the second metal peak. If a metal alloy is used, the result will often be a single absorption peak that approximates the weighted average of the two metals. It can be seen that the silver-gold absorption peak (lower transmission) lies between the silver and gold peaks, and this peak is a single narrower peak than if both pure metal nanoparticles are present. The peak width can be varied by having two different alloys present. Two pure metals can have the widest peak and the closer the two alloys are to the same composition the narrower the peak. Three or more compositions can also be used to yield more complex optical properties or even to yield very flat optical response over a desired range.

While there is some predictability of absorption properties of films containing metal alloy nanoparticles or a mixture of nanoparticles, there is a limit to such predictability. Light-absorption properties depend not only on the composition of the nanoparticulates, but on their size, size distribution, and shape. Thus, to optimize for a desired optical effect, some experimentation may have to be performed to empirically arrive at the desired result.

Nanoparticles useful in accordance with the invention generally have a mean particle diameter (when spherical) or mean greatest dimension between about 1 and about 50 nanometers. 50 nanometers is not an absolute upper limit, but when particles get substantially larger than this, light scattering or absorption may occur, resulting in undesirable haze or low transmission with nominal color effect.

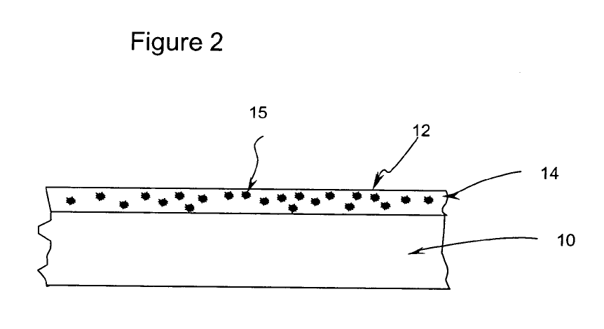

Illustrated in FIG. 2 is a coated substrate in accordance with the invention. The substrate 10 is glass or another transparent material. A thin film coating 12 is comprised of a matrix 14 containing dispersed nanoparticles 15.

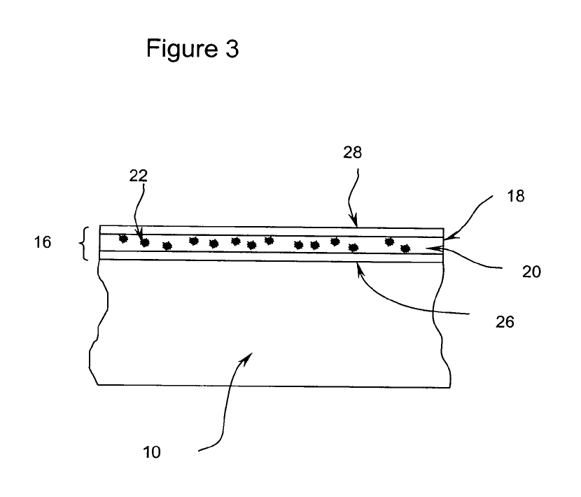

Illustrated in FIG. 3 is a specialized embodiment of the invention in which an optically tunable coating 16 is formed on the substrate 10. The tunable coating comprises an optical coating 18 comprising a matrix 20 having dielectric properties that change when an electric field is applied. The nanoparticles 22 may be selected from any suitable semiconductor or metallic material as described above. Such a material is barium strontium titanate, which, as described above, may be deposited by CCVD from a solution containing a mixture of barium, strontium, and titanium precursors. Prior to depositing the optical material thin film coating 18, a thin film electrode layer 26 of transparent conductive oxide (TCO) is deposited. Examples of TCOs that may be deposited by CCVD are indium tin oxide and zinc oxide. After the optical material coating thin film 18 is deposited, a second TCO electrode 28 is deposited. The thickness of the thin film TCO electrodes are typically 10 to 100 nanometers thick. The lower limit is only governed by the need that the electrode layers must be continuous, generally uniform, and non-porous. TCO electrode layers thicker than 100 nanometers can be used. The thickness of the TCO electrode layers depends on the anticipated current expected to be passed through, thicker layers leading to greater current capacitor and thicker response times. TCOs, though conductive, have high resistance. Coated optics in accordance with this embodiment of the invention can be made to change color (wavelength of light absorption) or change from light to dark depending upon application of an electric field.

Some advantages of the present invention can now be more fully appreciated; these include but are not limited to:
Increased temperature stability when compared to organic dyes
Increased fade resistance due to radiation degradation when compared to organic dyes
Increased optical densities (absorption at a desired wavelength) when compared to metal nanoparticle dispersions in bulk glass from melt processing
Unique tailorability of optical properties through the deposition of metal alloys of various composition and ratios
Unique tailorability of optical properties through the co-deposition of metal nanoparticles with a various dielectric matrixes
Electrically tunable optical absorption wavelength through the use of tunable dielectric matrixes, such as Ba₁₋ₓSrₓTi_{y}O₃ (BST)
Electrically tunable optical absorption intensity through the use of transparent conductive oxide layers in parallel plate configuration.

While applicants have discussed formation of optical coating materials and optical coating material thin films largely in respect to CCVD processes and modifications of CCVD processes, other processes by which large amounts of nanoparticles may be loaded into transparent matrices are also useful for forming the materials and composite material in accordance with the invention. Examples of such methods include, for example, the various chemical and physical vapor deposition process and such chemical processes such as precipitation and sol-gel.

Various features of the invention are set forth in the following claims:

What is claimed is:

1. An optical coating material comprising a transparent or translucent matrix material having dispersed therein nanoparticles formed of materials selected from the group consisting of semiconducting material, elemental metals, elemental metal alloys and mixtures thereof, providing that said metals and/or metal alloys exhibit a surface plasmon effect.

2. The optical coating of claim 1 wherein said dispersed nanoparticles comprise between about 1 and about 20 volume percent of said optical coating material.

3. The optical coating material of claim 1 wherein said transparent or translucent matrix material has dispersed therein between about 5 and about 20 volume percent of said nanoparticles

4. The optical coating material according to claim 1 wherein said nanoparticles have mean particulate diameters, when spherical, or mean greatest dimensions, between about 1 and about 50 nanometers.

5. The optical coating material according to claim 1 as a thin film on a high transmission optical substrate.

6. The optical coating material according to claim 1 as a thin film between about 10 nanometers and about 10 microns thick on an optical substrate.

7. The optical coating material according to claim 1 as a thin film between about 10 nanometers and about 1 micron thick on an optical substrate.

8. The optical coating material according to claim 1 wherein said nanoparticles are semiconducting material.

9. The optical coating material according to claim 1 wherein said nanoparticles are metals or metal alloys.

10. The optical coating material according to claim 1 wherein said nanoparticles comprise gold or silver.

11. The optical coating materials according to claim 1 wherein said nanoparticles are a metal alloy containing gold and/or silver.

12. The optical coating materials according to claim 1 wherein said matrix material is an oxide.

13. The optical coating material according to claim 1 wherein said matrix material is silica.

14. The optical coating material according to claim 1 wherein said matrix material is silicone.

15. The optical coating material according to claim 1 wherein said matrix material is an organic polymer

16. The optical coating material according to claim 1 wherein said matrix material is a tunable dielectric.

17. The optical coating material of claim 1 formed of alternating layers of said matrix material and at least one layer of said nanoparticles, said nanoparticles of said at least one layer covering between about 1% and about 60% of the surface area of adjacent matrix material layers and said matrix material layers acting to embed the nanoparticles of the nanoparticle layers.

18. The optical coating material of claim 17 wherein said nanoparticles cover between about 3% and about 40% of the surface of adjacent matrix material layers.

19. The optical coating material of claim 17 having at least three nanoparticle layers.

20. The optical coating material of claim 17 having at least six nanoparticle layers

21. An optically tunable device comprising a transparent substrate, a first thin film electrode layer formed on said substrate, an optical coating material according to claim 16 formed as a thin film formed on said first electrode layer, and a second thin film electrode layer formed on said optical material layer.

22. The device according to claim 21 wherein at least one of said thin film electrode layers is formed of a transparent conductive oxide.
